(19) United States
(12) Patent Application Publication
(10) Pub. No.: US 2012/0294226 A1
(43) Pub. Date: Nov. 22, 2012

(54) DISTRIBUTED RELAY FOR MULTI-HOP COMMUNICATION NETWORK

(75) Inventors: Andras Racz, Budapest (HU); Oscar Zee, Stockholm (SE); Zoltan Richard Turanyi, Szentendre (HU)

(73) Assignee: TELEFONAKTIEBOLAGET L M ERICSSON (PUBL), Stockholm (SE)

(21) Appl. No.: 13/521,514

(22) PCT Filed: Jan. 13, 2010
(86) PCT No.: PCT/SE10/50022

§ 371 Date: Jul. 11, 2012

(51) Int. Cl. H04W 40/00; H04W 84/12

(52) U.S. Cl. 370/315

(57) ABSTRACT

Radio coverage in areas with normally poor radio conditions can be improved using distributed relay nodes to relay communications between the base station and user terminal. The distributed relay node comprises two main functional components interconnected by a local area network. The functional components of the relay node comprise a terminal part that appears to the serving base station as another user terminal, and a base station part that appears to the user terminal as a base station. The terminal part and base station part of the relay node can be remotely located and interconnected by an existing local area network based IP protocols. A packet delivery mechanism transfers data packets between the terminal part and base station part of the relay node in a manner that is transparent to the rest of the mobile communication network.

### BACKGROUND

The present invention relates generally to multi-hop communication networks and, more particularly, to a distributed architecture for a relay in a multi-hop communication network.

The adoption of multi-hop communication has been proposed for Long Term Evolution (LTE) systems to improve the coverage and capacity of LTE networks. In multi-hop cellular systems, communications between the base station and a user terminal (UT) can take multiple hops with the help of additional intermediate nodes referred to herein as relay nodes. The connection between the base station and the relay node comprises an LTE radio interface instead of a wired connection. From the perspective of the base station, the relay node appears to be another user terminal. From the perspective of the user terminal, the relay node appears to be a base station.

A typical application for relay nodes is situations where coverage provided by the base station is inadequate. For example, relay nodes may be used to provide coverage improvement to user terminals located inside a building. In order to achieve improvement in coverage, the connection between the relay node and the base station should be significantly better than the connection between the relay node and the user terminal. Therefore, the relay node antenna providing connection with the base station is typically located so that the propagation conditions between the relay node antenna and the base station are good. In situations where the relay node is providing coverage for indoor locations, this requirement usually means that the relay node should be located on the roof of the building where it may have direct line of sight to the base station. To provide good radio coverage inside the building, it would be desirable for the antenna providing connection with the user terminal to be located inside the building. Thus, there is a conflict between the need to provide good radio coverage for the link between the base station and relay node, and good radio coverage for indoor locations.

A distributed antenna system for indoor locations could be used to resolve this conflict. In this solution, multiple antenna elements can be distributed in the building and connected to the base station via high capacity wired connections. One disadvantage of this approach is the need to provide high capacity, dedicated wired backhaul connection with the relay node.

Another option to improve indoor coverage is to use layer 1 repeaters or Femto base stations. However, repeaters have performance limitations due to their amplify-and-forward operational mode compared to relays. Further, relays have the advantage of not propagating noise and interference. Femto base stations may provide an alternative to relays but require wired backhaul connectivity to the operator's core network. Therefore, Femto base stations may be a more costly solution as compared to relays.

### SUMMARY

Radio coverage in areas with normally poor radio conditions can be improved using distributed relay nodes to relay communications between the base station and user terminal. The distributed relay node comprises two main functional components interconnected by a local area network. The functional components of the relay node comprise a terminal part that appears to the serving base station as another user terminal, and a base station part that appears to the user terminal as a base station. The terminal part and base station part of the relay node can be remotely located and interconnected by an existing local area network based IP protocols. A packet delivery mechanism transfers data packets between the terminal part and base station part of the relay node in a manner that is transparent to the rest of the mobile communication network.

In one exemplary embodiment, network address translation is used for routing packets between the terminal part and base station part of the relay. A network address translator in the terminal part of the relay configured to translate between a network address of the relay valid in the mobile communication network and a local relay address for the relay valid in a local area network. The address translator in said terminal part of said relay may be configured to translate source and destination addresses contained in control plane messages. The base station part of said relay is configured to use source and destination addresses associated with said terminal part of said relay in control plane messages originated by said base station part.

On another exemplary embodiment, the relay comprises multiple base station parts and the terminal part is allocated separate network addresses valid in the mobile communication network for each base station part.

In another exemplary embodiment, the base station part of said relay comprises a second address translator configured to translate a network address for a user terminal valid in the mobile communication network to a local address valid in the local area network to separate local network traffic on said local area network from traffic towards the mobile communication network.

In another exemplary embodiment, IP tunneling is used to route packers between the terminal part and base station part of the relay. A tunneling interface in the terminal part and base station part encapsulates data packets in tunneling packets and addresses the tunneling packets using the local address associated with either the base station part or the terminal part of the relay valid in the local area network.

In another exemplary embodiment, a dedicated Ethernet connection is used to route packers between the terminal part and base station part of the relay.

### BRIEF DESCRIPTION OF THE DRAWINGS

FIG. 1 illustrates an exemplary multi-hop communication network using relays between a serving base station and the user terminals to provide improved radio coverage.

FIG. 2 illustrates exemplary protocol layers used in a multi-hop communication system.

FIG. 3 illustrates an exemplary distributed relay according to one embodiment of the invention having a terminal part and a base station part.

FIGS. 4A and 4B illustrate exemplary relays using network address translation for forwarding packets between a terminal part and a base station part of the relay.

FIG. 5 illustrates exemplary protocol layers for a relay using network address translation for routing user plane data packets.

FIG. 6 illustrates exemplary protocol layers for a relay using network address translation for breakout of local user plane traffic on the local area network containing the relay.

FIG. 7 illustrates an exemplary relay using IP tunneling for routing data packets.

FIG. 8 illustrates exemplary protocol layers for a relay using IP tunneling for routing user plane data packets.

FIG. 9 illustrates an exemplary relay using Ethernet encapsulation for routing data packets.

FIG. 10 illustrates exemplary protocol layers for a relay system using Ethernet encapsulation for routing user plane data packets.

FIG. 11 illustrates exemplary protocol layers for a relay using network address translation for routing of control plane data packets.

FIG. 12 illustrates exemplary protocol layers for a relay using IP tunneling for packet routing of control plane data packets.

FIG. 13 illustrates exemplary protocol layers for a relay using Ethernet tunneling for routing of control plane data packets.

FIG. 14 illustrates an exemplary method for routing packets between parts a distributed relay.

FIG. 15 illustrates the main functional components of an exemplary distributed relay according to one embodiment.

### DETAILED DESCRIPTION

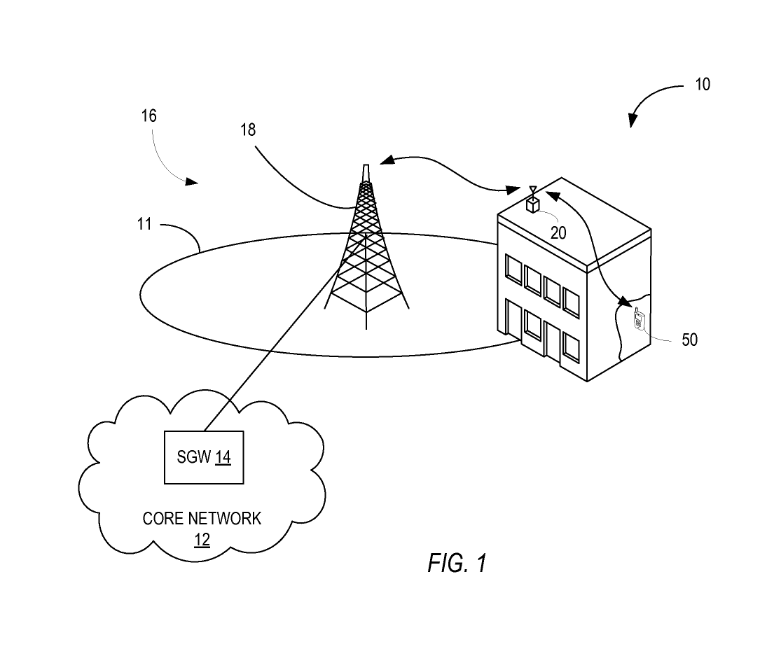

FIG. 1 illustrates an exemplary communication network 10 indicated generally by the numeral 10 that employs a relay 20 for communication with one or more user terminals 50 in an indoor location, such as inside a building. Communication network 10 comprises a core network 12 and radio access network 16. The core network 12 includes a serving gateway node (S-GW) 14 and provides a connection to a packet data network, such as the Internet. The S-GW 14 routes traffic to and from user terminals 50 operating within the communication network 10. The radio access network 16 comprises a plurality of base stations 18 providing radio coverage in respective cells 11 of the communication network 10. In the exemplary communication network 10, a relay 20 is used to relay signals between the base station 18 and one or more user terminal 50 at an indoor location. A radio interface is used for communication between the relay 20 and base station 18. In one embodiment, the radio interface between the relay 20 and base station 18 is the same as the radio interface between the relay 20 and user terminal 50. The radio technology used for the radio interface between the relay 20 and serving base station 18 is based on the same radio technology used for communications with the user terminals 50, possibly with some additional extensions to optimize for the backhauling application. As an example, when the serving base station 18 and the relay 20 use LTE radio access for communication with user terminals 20 within the cell, LTE-based, or at least LTE-like, radio link should also be used for the radio link between the relay 20 and base station 18.

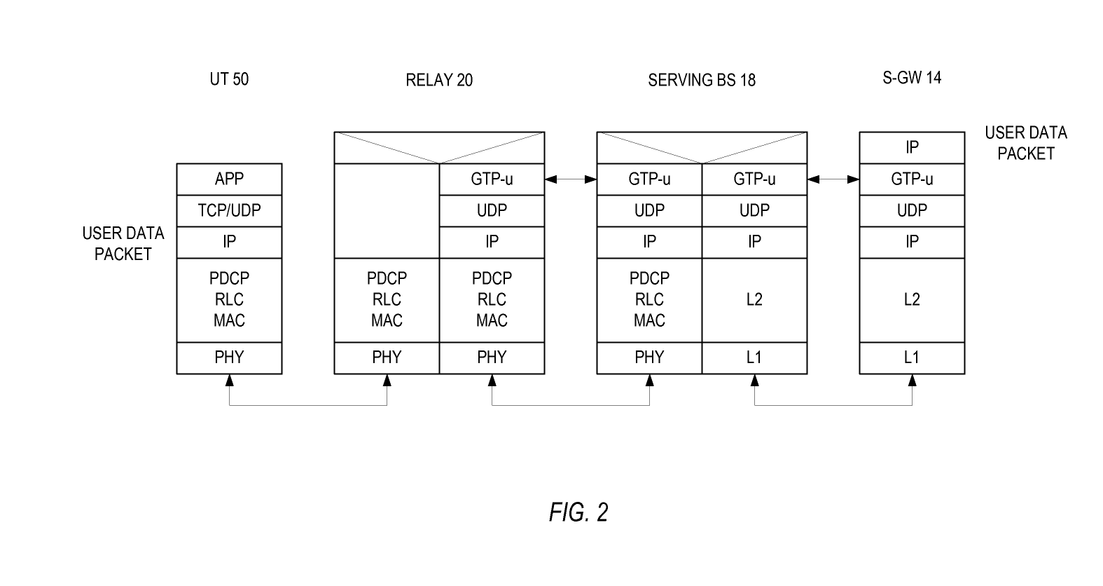

FIG. 2 illustrates one exemplary end-to-end protocol stack architecture where the serving base station 18 hides the relay 20 from the core network 14. Thus, a user terminal 50 served by the relay 20 is seen from the rest of the network 10 as being served directly via the serving base station 18. A downlink (DL) transmission can be followed from right to left in FIG. 2. It can be seen that downlink packets, denoted IP-u, for the user terminal 20 are first tunneled from the serving gateway (S-GW) 16 in the core network 14 to the serving base station 30 (downlink), as the S-GW 16 believes that the user terminal 20 is connected to the base station 18.

The most straightforward way for the serving base station 18 to forward the data packets to the user terminal 50 is to translate the incoming GTP tunnel to an outgoing GTP tunnel toward the relay 20 with a one-to-one mapping, i.e., there is one GTP tunnel per user terminal bearer on the backhaul link as well. The base station 18 maps the packets to a common backhaul radio bearer, i.e., the packets of multiple user terminals 50 are sent on the same radio bearer on the backhaul link. There may be multiple backhaul radio bearers for different QoS classes. After the packets arrive at the relay 20, the relay 20 maps the packets to the corresponding user terminal radio bearers 50 on the link between the relay 20 and user terminal 50 based on the GTP tunnel ID (TEID) and transmits the data packet to the user terminal 50. Other techniques for identifying the appropriate radio bearer are described in PCT Application. Patent Application No. PCT/SE2009/051136 filed on 9 Oct. 2009 titled “Radio Bearer Identification for Self Backhauling and Relaying in LTE Advanced.”

The Generic Tunneling Protocol GTP-u, the Universal Datagram Protocol (UDP), and Internet Protocol (IP) can be used for the GTP tunnel between the SGW 14 and the serving base station 18, and for the GTP tunnel between the serving base station 18 and the relay 20. The lower layer protocols used for the communication between the SGW 14 and serving base station 18 include L1 (physical layer) and L2 (data link layer) protocols. These protocols may vary depending on the type of network. The link between the serving base station 18 and the relay, as well as the link between the relay 20 and the user terminal 50 use the LTE air interface protocols. In particular, the link uses the LTE Medium Access Control (MAC) protocol, the LTE Radio link Control (RLC) protocol, and the LTE Packet Data Convergence (PDCP) protocol.

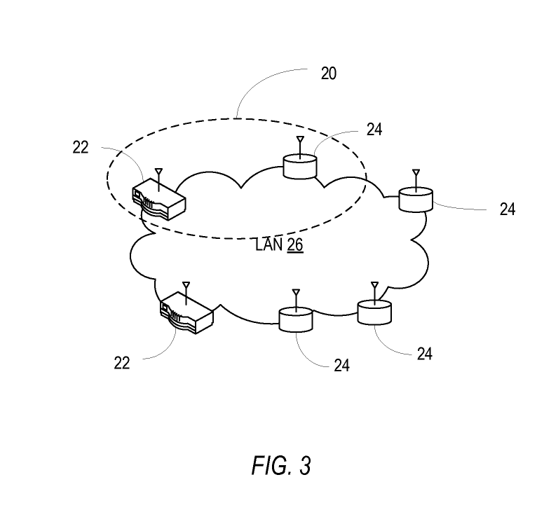

Referring to FIG. 3, the relay 20 is split into two functional components referred to herein as the terminal part 22 and the base station part 24. The terminal part 22 provides the backhaul connection to the local communication network, and the base station part 24 provides access link connection to the user terminals 50. The terminal part 22 and base station part 24 are connected via a dedicated point-to-point connection or by a local area network 26 implementing standard network protocols, denoted IEEE.xx, such as the IP protocol. By splitting the terminal part 22 and base station part 24, it is possible to deploy the two parts at different physical locations. For example, in the situation where it is desired to improve coverage inside a building, the terminal part 22 may be located on top of the building where it may be in line-of-sight (LOS) with the base station 18, and the base station part 24 may be located inside the building to improve coverage inside the building.

The terminal part 22 may connect via the local area network 26 with two or more base station parts 24 to effectively form a distributed antenna system. Also, two or more terminal parts 22 may connect to the same base station part 24. A packet delivery mechanism, described in more detail below, enables routing of data packets between the terminal parts 22 and the base station parts 24 in a manner that is transparent to the rest of the network 10. The local area network 26 may use existing wiring or cabling available inside the building. For example, the terminal parts 22 and base station parts 24 may be connected over existing power lines using Ethernet protocol, over existing telephone lines using xDSL protocol, or via existing Ethernet cabling for local area networks inside the building. The network could also be used to connect other devices, such as wireless local area network (WLAN) access points.

For routing purposes, the terminal part 22 and base station part 24 of the relay 20 need to resolve differences between the addresses used in the mobile communication network 10 and the addresses used in the local network connecting the terminal part 22 with the base station part 24. Each of the devices operating in the mobile communication network 10 will have an internal network address, hereinafter referred to as the network address, assigned by the network operator. Additionally, the terminal part 22 and base station part 24 will also have addresses used for packet delivery over the local area network 26. This address is referred to herein as the local address. The address space for the local area network 26 will be different than the address space for the mobile communication network 10.

A number of approaches are available for resolving differences between the address space in the mobile communication network 10 and the address space in the local area network 26. Three different approaches are described herein, although other approaches are possible. One approach is to use network address translation (NAT) for translating between the operator's internal network addresses and the local addresses used in the local area network 26. A second approach is to use IP tunneling to tunnel the data packets between the terminal part 22 and base station part 24. A third approach uses a dedicated Ethernet connection to provide transport for data packets sent between the terminal part 22 and base station part 24. Each of these approaches is described in more detail below.

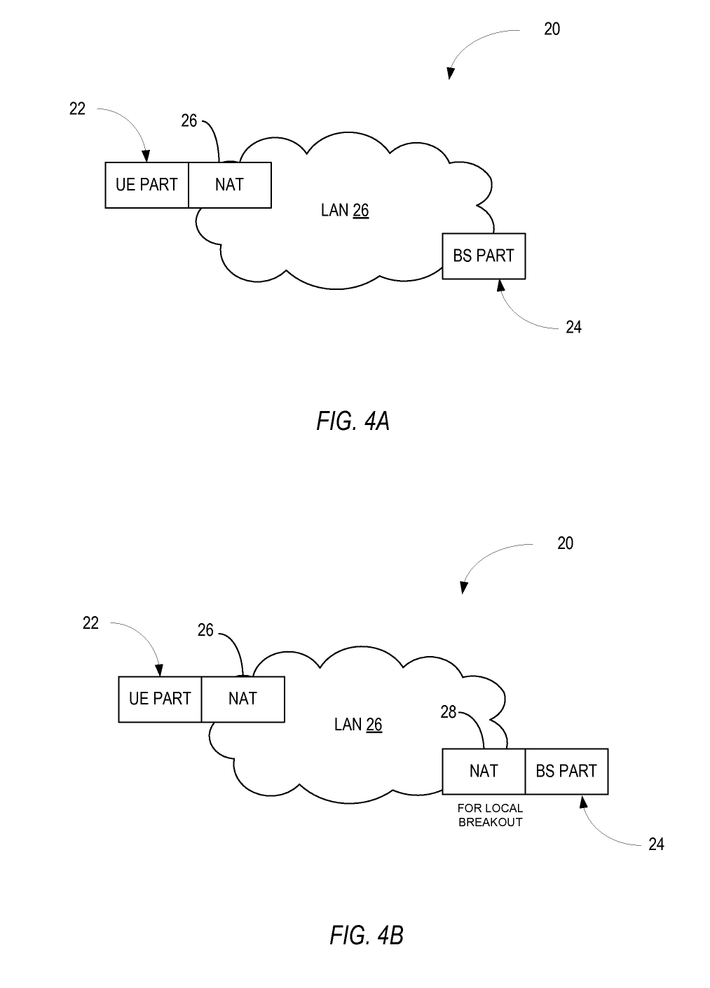

FIGS. 4A and 4B illustrate a relay 20 that uses the NAT approach. In FIG. 4A, the user terminal 22 part combines normal user terminal functionality for communicating with the serving base station 18 with NAT-based address translation. A NAT device 26 is incorporated into the terminal part 22 to translate between the operator's internal network address valid in the mobile communication network 10 and the local addresses valid in the local area network 26. The base station part 24 includes normal base station functionality for communicating with the user terminal 50 and may optionally include NAT functionality for breakout of local traffic on the local area network 26 as hereinafter described.

The NAT device in the terminal part 22 makes the division of the relay 20 transparent to both the core network and possibly the base station part 24 of the relay 20 depending on the implementation. In this embodiment, the terminal part 22 contains a NAT device 26 translating the address of the relay 20 between the operator's internal network address and the local address for all data packets traversing the relay 20. The NAT device 26 may also use port translation if there are multiple base station parts 24, or if communication between the core network and terminal part 22 is desired in addition to communication between the core network and base station part 24. In the embodiments shown in FIG. 4B, a separate NAT device 28 is incorporated into the base station 24 for breakout of local traffic as will be describe in more detail below.

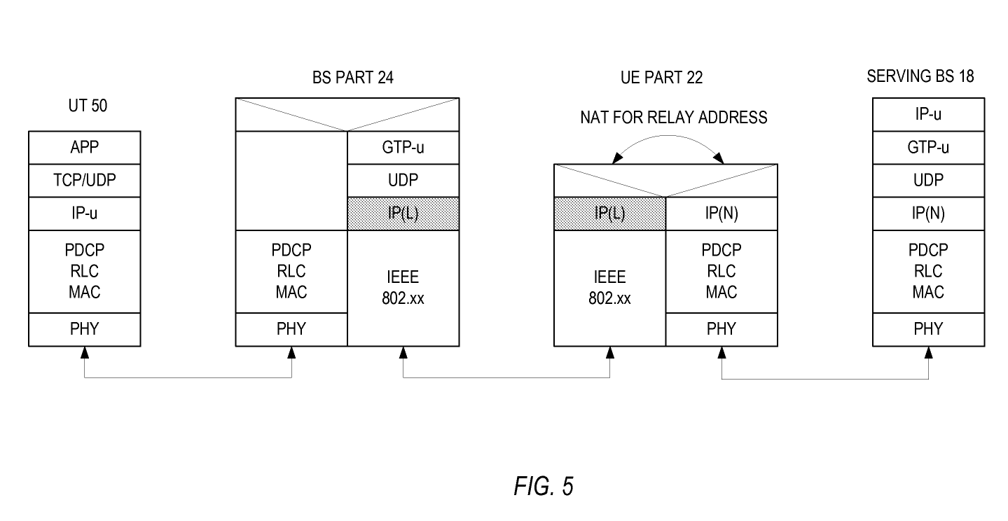

FIG. 5 illustrates an exemplary protocol stack for a distributed relay 20 using network address translation at the terminal part 22. In this embodiment, user plane data packets (IP-u) received by the serving base station 18 over the LTE air interface are tunneled from the serving base station 18 to the relay 20 using the GTP-u protocol. The serving base station 18 encapsulates the user plane data packets IP-u in an GTP packet and uses the network address, denoted IP(N), for the relay 20 to address the GTP packet. When the GTP packet arrives at the user terminal 22, the NAT device 26 in the UE part 22 translates the destination address in the GTP packet from the network address IP(N) valid in the mobile communication network 10 to the local address IP(L) of the base station part 24 of the relay 20 valid in the local area network 26 and forwards the GTP packet to the base station part 24. The base station part 24 decapsulates the GTP packet to extract the user plane data packet IP-u and delivers the user plane data packet IP-u to the application layer.

For uplink communications, the base station part 24 receives the user plane data packet IP-u from the user terminal 50 over the LTE air interface. The base station part 24 maps the user plane packet to a corresponding GTP-U tunnel between the relay 20 and the serving base station 18 based on the particular user terminal context. The base station part 24 encapsulates the user plane data packet IP-u in a GTP packet and uses the local address of the terminal part 22 of the relay 20 to address the GTP packet. The NAT device 26 in the terminal part 22 translates the address of the terminal part 24 of the relay from the local address IP(L) used in the local area network to the operator's internal network address IP(N) and forwards the GTP packet to the serving base station 18. Note that in the embodiment shown in FIG. 5, the GTP tunnel extends from the serving base station 18 to the base station part 24 and that the network address translation operates within the tunnel.

FIG. 4B illustrates a second optional NAT device in the base station part 24 of the relay 20. The purpose of the NAT in the base station part 24 is for breakout of local traffic. There may be circumstances when user terminals 50 connecting to base station parts 24 on the same local area network 26 are communicating with one another. In conventional networks employing relays 20, data packets sent from one user terminal 50 to another would be relayed to the serving base station 18, and then relayed back from the serving base station 18 to the other user terminal 50. Thus, the user plane data packet traverses the relay 20 twice. In the exemplary embodiment shown in FIG. 4B, data packets transmitted between user terminals 50 served by relays 20 on the same local area network 26 may be routed directly by the base station part 24 from the originating user terminal 50 to the receiving user terminal 50. The breakout of local traffic reduces the traffic on the connection between the terminal part 24 and the serving base station 18.

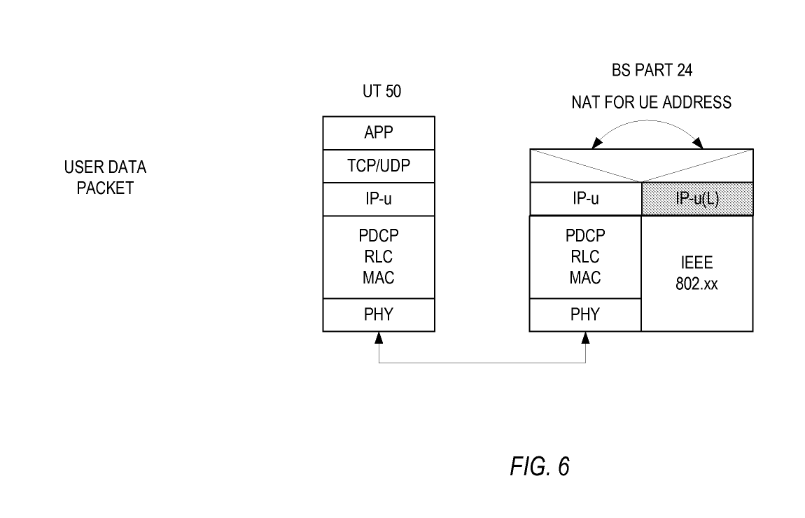

FIG. 6 illustrates exemplary protocol layers for a relay 20 using network address translation in the base station part 24 for breakout of local user plane traffic on the local area network 26. In this embodiment, the base station part 24 receives a user plane data packet IP-u from the originating user terminal 50 over the LTE air interface. Based on the destination address of the user plane data packet IP-u, the base station part 24 determines whether local breakout is required. If so, the base station part 24 performs address translation on the destination user terminal address and translates the user terminal address to a local address for the user terminal 50.

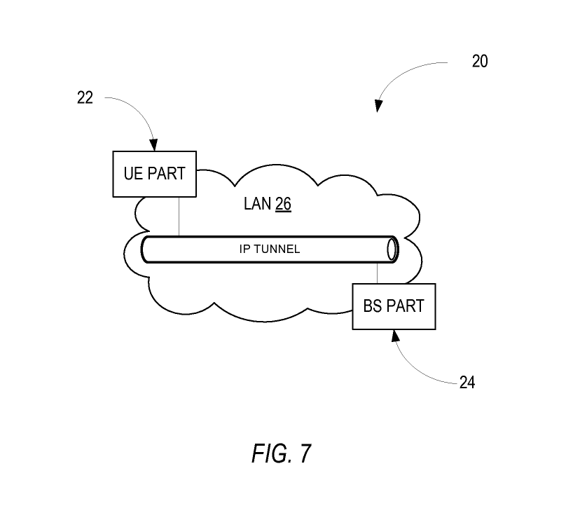

FIG. 7 illustrates an alternate method of routing packets between the terminal part 22 and base station part 24 using IP tunneling. In this embodiment, the user terminal 22 part combines normal user terminal functionality for communicating with the serving base station 18 with IP tunneling capability for communicating with the base station part 24 of the relay 20. The base station part 24 includes normal base station functionality for communicating with the user terminal 50 and IP tunneling capability for communicating with the terminal part 22 of the relay 22.

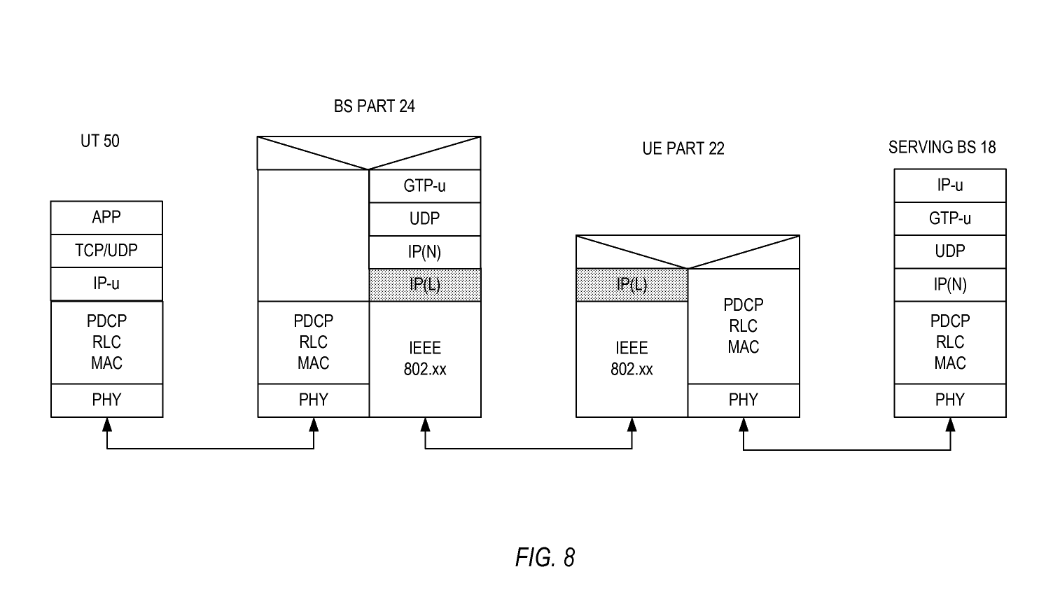

FIG. 8 illustrates a protocol stack for a relay implementing IP tunneling. As shown in FIG. 8, a GTP tunnel is created between the serving base station 18 and base station part 24 of the relay 20 for routing packets between the serving base station 18 and relay 20. A second, nested IP tunnel is created between the terminal part 22 and base station part 24 of the relay 20. The serving base station 18 encapsulates the user plane data packet IP-u in a GTP packet and sends the GTP packet to the relay 20. The terminal part 22 receives the GTP packets from the serving base station 18 over the LTE air interface, encapsulates the GTP packets in an outer IP packet, and forwards the encapsulated GTP packet to the base station part 24. The base station part 24 decapsulates both the outer IP packet and inner GTP packet in that order and forwards the user plane data packet IP-u to the user terminal 50 over the LTE air interface. For the inner GTP packet, the serving base station 18 uses the network address of the relay 20. For the outer IP packet, the terminal part 22 uses the local address of the base station part 24 of the relay 20.

For uplink communications, the base station part 24 receives user plane data packets IP-u from the user terminal 50 over the LTE air interface and encapsulates the user plane data packet IP-u twice. The first inner encapsulation is made for delivering the data packet over the GTP tunnel between the base station part 24 and serving base station 18. The second outer encapsulation is for delivering the GTP packet over the tunnel between the base station part 24 and terminal part 22. For the inner GTP packet, the base station part 24 uses the network address of the serving base station 18 valid in the mobile communication network 10. For the outer IP packet, the base station part 24 uses the local address of the terminal part 22.

In one exemplary embodiment, the terminal part 22 may communicate with multiple base station parts 24. The user terminal part 22 obtains an IP address for each base station part 24 by opening a new packet data network (PDN) connection using a different access point name (APN). Alternatively, the terminal part 22 may add an IPv6 prefix on its existing PDN connection and assign one IPv6 address to the base station part 24. Any method of determining an IP address suffices as long as an IP address from the operator's network address space can be assigned. This IP address is conveyed to the base station part 24 at initialization time, together with the tunnel setup. The base station part 24 assigns this address to the virtual interface corresponding to the GTP tunnel and uses it for further communication with the core network. This way the S1 application in the relay-UE and relay-eNB need no changes at the expense of a simple tunneling mechanism and some extra packet overhead in the LAN.

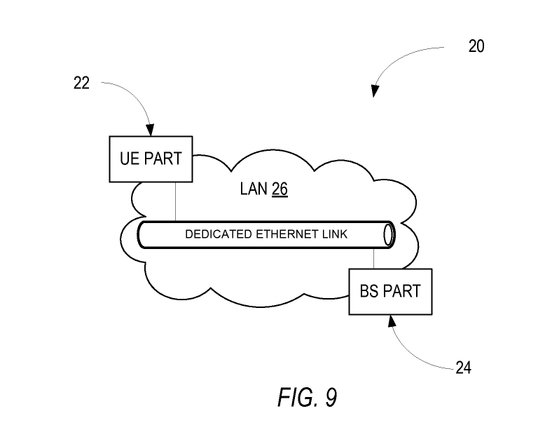

FIG. 9 illustrates a third method for routing packets over the local area network 26. In this embodiment, GTP packets received from the serving base station 28 are delivered using a dedicated Ethernet connection. The user terminal 22 part combines normal user terminal functionality for communicating with the serving base station 18 with Ethernet networking capability for communicating with the base station part 24 of the relay 20. The base station part 24 includes normal base station functionality for communicating with the user terminal 50 and Ethernet networking capability for communicating with the terminal part 22 of the relay 22.

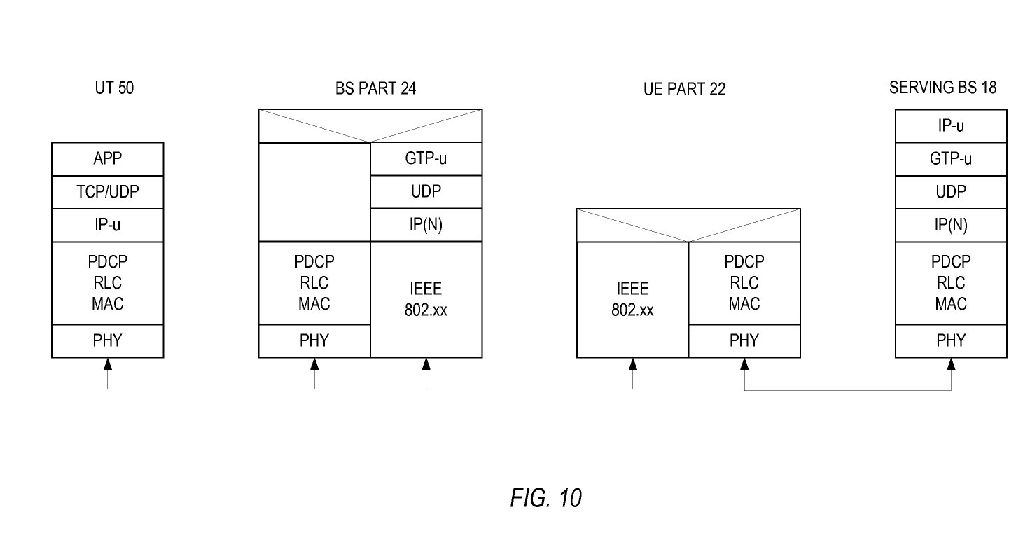

FIG. 10 illustrates a protocol stack for a relay 20 using a dedicated Ethernet connection. A GTP tunnel is created between the serving base station 18 and base station part 24 of the relay 20 for routing packets between the serving base station 18 and relay 20 as previously described. The serving base station 18 encapsulates the user plane data packet IP-u in a GTP packet and sends the GTP packet to the relay 20. The serving base station 18 uses the network address of the relay 20 valid in the mobile communication network 10 as the destination address for the GTP packet. The terminal part 24 receives the GTP packet from the serving base station 18 over the LTE air interface and forwards the encapsulated GTP packet over the dedicated Ethernet connection to the base station part 24. When the base station part 24 receives the GTP packet, the base station part 24 decapsulates GTP data packet and forwards the user plane data packet IP-u to the user terminal 50 over an LTE air interface.

For uplink communications, the base station part 24 receives the user plane data packet IP-u from the user terminal 50 over the LTE air interface. The base station part 24 encapsulates the user plane data packet IP-u in a GTP packet and forwards the GTP packet to the terminal part 22 over a dedicated Ethernet connection. The terminal part 22 then forwards the packet to the serving base station 18 over the LTE air interface.

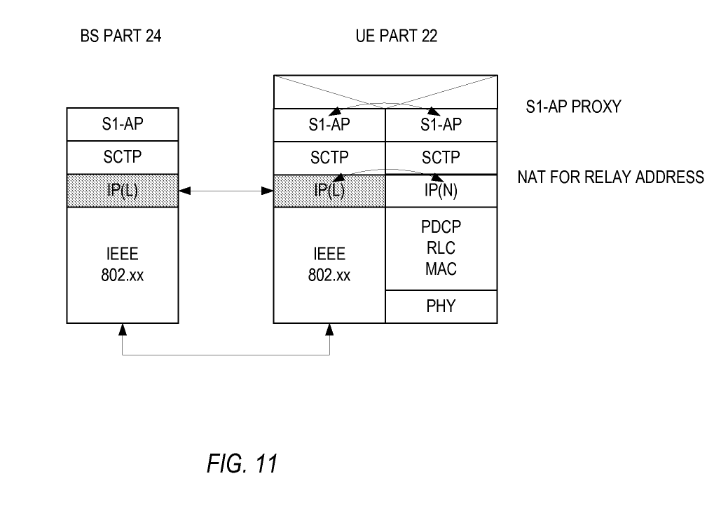

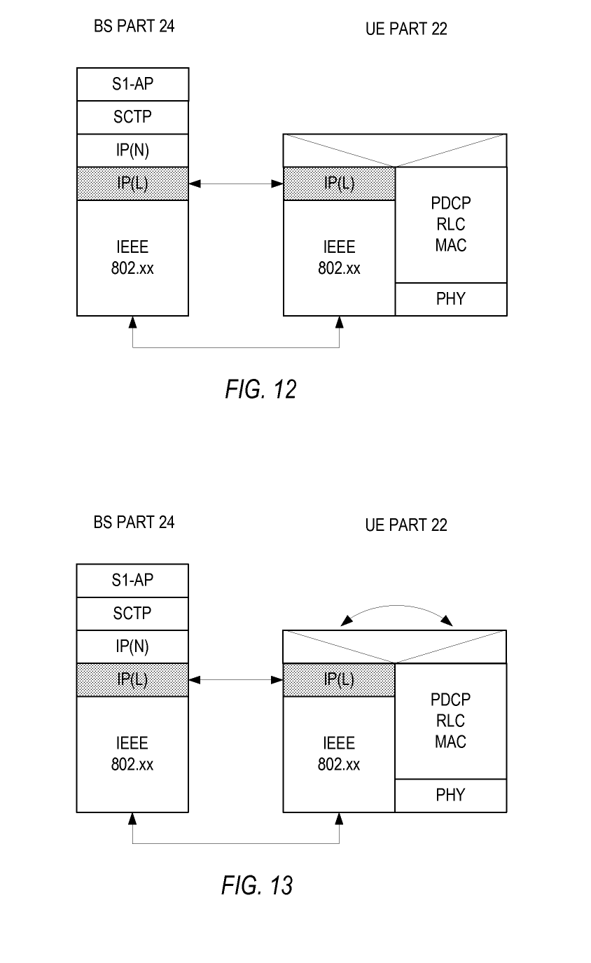

FIGS. 11-13 illustrate the routing of control plane data packets between the SGW 14 and relay 20. FIG. 11 illustrates routing using network address translation. FIG. 12 illustrates routing of control plane data packets using IP tunneling. FIG. 13 illustrates routing of control plane data packets using Ethernet switching.

Referring to FIG. 11, the terminal part 24 receives the control plane data packets (represented by the S1-AP and SCTP layers) encapsulated in a GTP packet transmitted from the SGW 14. In this embodiment, the terminal part 22 includes a NAT device operating at the IP layer to translate the address of the GTP packets and an S1-AP proxy to translate source and destination addresses contained within the S1-AP control messages. The GTP packets are addressed using the network address of the relay 20 valid in the mobile communication network. The terminal part 22 translates the destination address in the GTP packet from the network address used in the mobile communication network 10 to the local address of the base station part 24, and forwards the GTP packet to the base station part 24 over the local area network 26. For uplink communications, the base station part 24 uses the local address for the terminal part 22 associated with the SGW 14 to address the packets sent to the SGW 14. Note that the terminal part 22 includes different local address for different SGWs 14. The terminal part 22 translates the address of the GTP packet from the local address used in the local area network 26 to the network address used in the mobile communication network 10 and forwards the packet toward the SGW 14 over the LTE interface. The S1-AP proxy also translates source and destination addresses contained within control plane data packets.

FIG. 12 illustrates a control plane protocol stack for a relay 20 using IP tunneling to route control plane data packets between the terminal part 22 and base station part 24. In this embodiment, the control plane data packets arrive at the terminal part 22 encapsulated in an GTP packet sent by the SGW 14. The destination address of the tunneling packet is the network address of the relay 20 valid in the mobile communication network 10. The terminal part 22 creates a second nested tunnel by encapsulating the received GTP packet in an IP packet. The local address of the base station part 24 is used to address the outer IP packet. When the base station 24 part 24 receives the twice-encapsulated control plane data packet, it decapsulates the outer IP packet and inner GTP packet to extract the control plane data packet.

For uplink communications, the control plane messages are encapsulated in an inner GTP packet for delivery over a tunnel to the SGW 14. The inner GTP packet is then encapsulated in an outer IP packet for delivery over a second tunnel to the terminal part 22. Upon receipt of the twice-encapsulated control plane data packet, the terminal part 22 decapsulates the outer IP packet and forwards the inner GTP packet toward the SGW 14.

FIG. 13 illustrates a control plane protocol stack for a relay 20 using Ethernet networking for routing packets between the terminal part 22 and base station part 24. In this case, control plane data packets encapsulated in GTP packets arrive at the terminal part 22 over a tunnel between the SGW 14 and the base station part 24. The GTP packets arrive over an LTE air interface. The terminal part 22 forwards the GTP packet over the local area network 26 toward the base station part 24 over a dedicated Ethernet connection When the base station part 24 receives the GTP packet, it decapsulates the GTP packet and delivers the control plane data packets to the appropriate protocol layers.

Some embodiments of the invention may use a NAT-aware base station part 24 for routing of control plane messages.

For control plane data packets originating the with base station part 24, the base station part 24 encapsulates the control plane data packets in a GTP packet and forwards the encapsulated control plane data packets toward the SGW 14 over a dedicated Ethernet connection with the terminal part 22. The terminal part 22, forwards the GTP packet towards the SGW 14 over the LTE air interface to the serving base station 18.

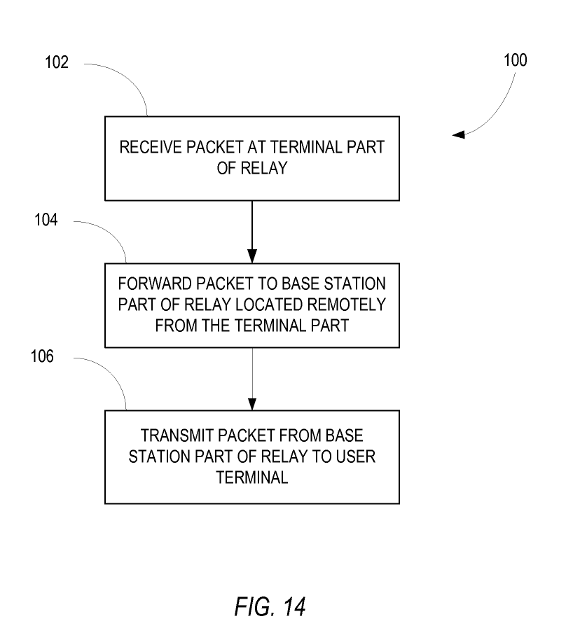

FIG. 14 illustrates an exemplary method 100 for routing data packets between a terminal part 22 and base station part 24 of a distributed relay 20. The method begins when the terminal part 22 receives a data packet for a user terminal 50 (block 102). The terminal part 22 forwards the data packet to the base station part 24 of the relay 20 located remotely from the terminal part 22 (block 104). Any of the above-described methods may be used for routing the data packet. Particularly, the terminal part 22 may use the NAT approach, the IP tunneling approach, or the Ethernet networking approach for routing the data packets to the base station part 24. Upon receipt of the data packets, the base station part 24 of the relay transmits the data packet to the user terminal over an LTE interface (block 106)

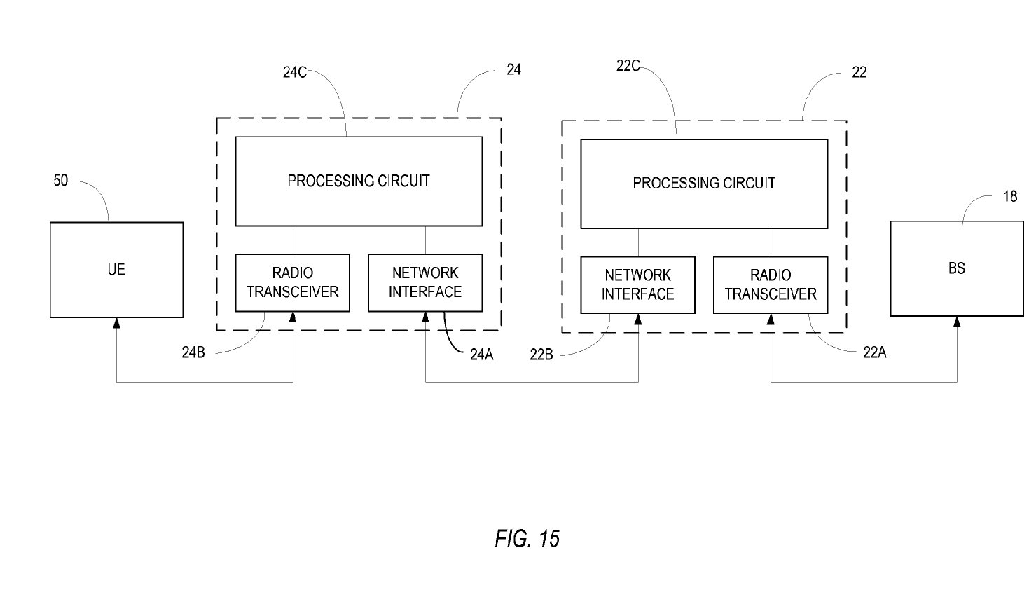

FIG. 15 is a functional block diagram illustrating the main components of the relay 20. The relay 20, as previously noted, includes a terminal part 22 and base station part 24 remotely located from one another. The terminal part 22 and base station part 24 may be connected by a local area network using standard networking protocols, such as the IP protocol. The terminal part 22 comprises a radio transceiver 22A, networking interface 22B, and a processing circuit 22C. The radio transceiver 22A may, for example, comprise an LTE radio transceiver operating substantially according to the LTE standard. The networking interface 22B may comprise a conventional TCP/IP interface for communicating with the base station part 24 over an IP network. The processing circuit 22C comprises one or more processors, hardware, or a combination thereof, configured to carry out the method as described herein. In this regard, it may be noted that the processing circuit 22C may be programmed to implement the various protocols shown in the FIGS. 2, 6, 8, and 10. The base station part 24 comprises a radio transceiver 24A, network interface 24B, and processing circuit 24C. The radio transceiver 24A may comprise a conventional LTE transceiver for communicating with the user terminal 50. The network interface 24B provides connection with the local area network 26 and implements standard networking protocols, such as a TCP/IP and Ethernet for communicating with the terminal part 22. The processing circuit 24C contains one or more processors, hardware, or a combination thereof, and is programmed to carry out the methods described herein. In this regard, it may be noted that the processing circuit 22C may be programmed to implement the various protocols shown in the FIGS. 2, 6, 8, and 10-13.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A relay for relaying packets transmitted between a base station in a mobile communication network and one or more user terminals, said relay comprising:
a terminal part for communicating with a base station in a mobile communication network;
a base station part located for communicating with one or more user terminals, said base station part located remotely from said terminal part and connected with said terminal part by a local area network; and
a packet forwarding interface between the terminal part and the base station part of the relay for transmitting packets between the terminal part and base station part of the relay.

2. The relay of claim 1 wherein packet forwarding interface comprises a first address translator in the terminal part of the relay configured to translate between a network address of the relay valid in the mobile communication network and a local relay address for the relay valid in a local area network.

3. The relay of claim 2 wherein said address translator in said terminal part of said relay is configured to translate source and destination addresses contained in control plane messages.

4. The relay of claim 2 wherein said base station part of said relay is configured to use source and destination addresses associated with said terminal part of said relay in control plane messages originated by said base station part.

5. The relay of claim 2 wherein said relay further comprises multiple base station parts and wherein the terminal part is allocated separate network addresses valid in the mobile communication network for each base station part.

6. The relay of claim 2 further wherein said base station part of said relay comprises a second address translator configured to translate a network address for a user terminal valid in the mobile communication network to a local address valid in the local area network to separate local network traffic on said local area network from traffic towards the mobile communication network.

7. The relay of claim 1 wherein the packet forwarding interface comprises a tunneling interface configured to tunnel packets between said terminal part and said base station part of said relay.

8. The relay of claim 7 wherein the tunneling interface encapsulates data packets received in tunneling packets and addresses said tunneling packets to using the local address associated with one of the base station part and terminal part of the relay valid in the local area network.

9. The relay of claim 1 wherein the packet forwarding interface comprises an Ethernet interface configured for a dedicated connection between the terminal part and the base station part of the relay.

10. A method of relaying packets between a base station in a mobile communication network and a user terminal, said method comprising:
receiving a packet at a terminal part of a relay located between the base station and the user terminal;
forwarding the packet for the user terminal from a terminal part of the relay to a base station part of said relay located remotely from said terminal part and connected by a local area network; and
transmitting said packet from said base station part of said relay to said user terminal.

11. The method of claim 10 wherein forwarding the packet for the user terminal from a terminal part of the relay to a base station part of said relay located remotely from said terminal part comprises translating, at said terminal part of said relay, between a network address of said relay valid in the mobile communication network and a local relay address valid in a local area network.

12. The method of claim 11 further comprising translating source and destination addresses contained in control plane messages at said terminal part of said relay.

13. The method of claim 11 further comprising using source and destination addresses associated with said terminal part of said relay in control plane messages originated by said base station part of said relay.

14. The method of claim 11 further comprising routing packets between said mobile communication network and two or more base station parts by translating separate relay addresses allocated to said relay for each base station part to corresponding local addresses for the base station parts.

15. The method of claim 11 further comprising separating local traffic on the local area network by translating, at said base station part of said relay, a network address for a user terminal valid in the mobile communication network to a local address valid in the local area network.

16. The method of claim 10 wherein the packet forwarding interface comprises tunneling packets between said terminal part and said base station part of said relay.

17. The method of claim 16 wherein tunneling packets between said terminal part and said base station part of said relay comprises encapsulating said data packets in tunneling packets and addressing said tunneling packets using an address associated with one of the terminal part and the base station part of the relay valid in the local area network.

18. The method of claim 10 wherein the packet forwarding interface comprises an Ethernet interface configured for a dedicated connection between the terminal part and the base station part of the relay.
